(19) United States
(12) Patent Application Publication
(10) Pub. No.: US 2012/0292954 A1
(43) Pub. Date: Nov. 22, 2012

(54) CAR SEAT SNACK TRAY

(76) Inventor: Robert Chatwin, Costa Mesa, CA (US)

(21) Appl. No.: 13/296,146

(22) Filed: Nov. 14, 2011

Related U.S. Application Data
(60) Provisional application No. 61/412,551, filed on Nov. 11, 2010.

(51) Int. Cl. B60N 2/44; A47B 83/02

(52) U.S. Cl. 297/135

(57) ABSTRACT

A car seat snack tray for use and integration with a child's car seat is disclosed. A car seat snack tray in accordance with the present invention comprises a bowl, having a receptacle defined by a wall and a bottom, which allows access to solids and liquids contained therein, and a stem, attached to the bowl, having a sidewall and a base, wherein the stem slides inside a cupholder along the length the sidewall until the base reaches the bottom surface of the cupholder.

The present application claims priority to provisional patent application entitled, “Car Seat Snack Tray,” filed on Nov. 11, 2010 and assigned U.S. application Ser. No. 61/412,551.

### BACKGROUND OF THE INVENTION

1. Field of the Invention.

The present invention is in the field of accessories for children's car seats, and in particular to a tray that can fit into a cupholder of a children's car seats.

2. Background of the Invention

Children's car seats are designed to keep children safe from hazardous road conditions and accidents. In addition, children's car seats allow the parents and other carekaters to focus on the driving without being distracted. Recently, to further the benefit of children's car seats, cupholders have been added to allow children to have easy access to beverages. However, small children still have nowhere to store their snacks, toys or crayons.

It can be seen, then, that there is a need in the art for a bowl that can be attached to a children's car seat for use by the children during travel.

### SUMMARY OF THE INVENTION

To minimize the limitations in the prior art, and to minimize other limitations that will become apparent upon reading and understanding the present specification, the present invention discloses an apparatus for containing solids and liquids. A car seat snack tray in accordance with the present invention comprises a bowl, having a receptacle defined by a wall and a bottom, which allows access to solids and liquids contained therein, and a stem, attached to the bowl, having a sidewall and a base, wherein the stem slides inside a cupholder along the length the sidewall until the base reaches the bottom surface of the cupholder.

Such an apparatus further comprises a stem that is 6 inches in length, a bowl that is 3 inches in depth, a bowl that is oval in shape, and a stem surface that is ribbed to provide friction between the stem and the cupholder to create a stopping effect.

In addition, such an apparatus may further comprise a stem that is mechanically extendable and a base that is mechanically expandable.

It is an object of the present invention to provide an apparatus that allows children to access solids and liquids using a tray directly from a cupholder of children's car seat. It is another object of the present invention to provide an apparatus that is safe for use with children's car seats.

Other features and advantages are inherent in the system and method claimed and disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a perspective view of an embodiment of the car seat snack tray of the present invention;

FIG. 2 illustrates a top view of the car seat snack tray of FIG. 1

FIG. 3 illustrates a front cross-sectional view of the car seat snack tray assembly of FIG. 1;

FIG. 4 illustrates a perspective view of the car seat snack tray of FIG. 1 inserted within a cupholder of a children's car seat.

### DETAILED DESCRIPTION OF THE DRAWINGS

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

### Specifics of the Invention

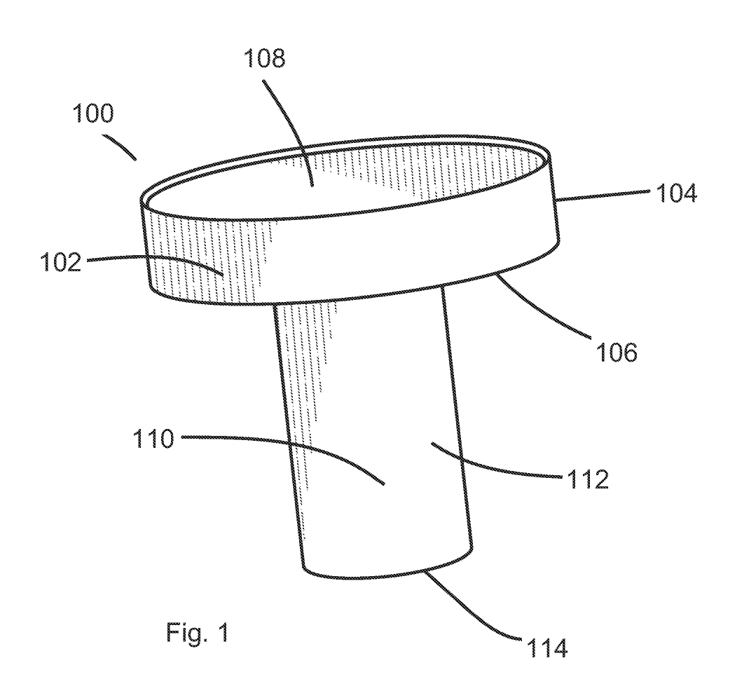

FIG. 1 illustrates a perspective side view of the car seat snack tray 100. The car seat snack tray 100 includes a bowl 102 comprising an outerwall 104, a bottom 106, and a bowl receptacle 108. The bowl 102 extends upwardly from the bottom 106 along the outerwall 104 to form the bowl receptacle 108 for containing liquids and solids. The car seat snack tray 100 further includes a stem 110. The stem 110 includes a sidewall 112 and a base 114. Although shown as a single unit, and, preferably, in final form comprises a single unit, car seat snack tray 100 can be manufactured from several units if desired.

Bowl 102 of the car seat snack tray is typically circular in shape and is typically made from dishwasher-safe, shatter-proof, non-BPA plastic. However, bowl 102 can be square, oval, rectangular, triangular, or any other shape obvious to one skilled in the art that will not interfere with the child's movement in the car seat, including ingress and egress from the car seat, without departing from the scope of the present invention. Further, bowl 102 can be made from steel, aluminum, other metals, cardboard, wood, wax, ceramic, or other materials obvious to one skilled in the art, or combination of these materials without departing from the scope of the present invention.

Stem 110, as shown, is typical cylindrical and comprises a cylindrical sidewall 112 which extends up to the bowl 102 from the base 114. However, stem 110 can be square, rectangular, spherical or any other shape obvious to one skilled in the art that can accommodate a cupholder of children's car seat without departing from the scope of the present invention. Further, stem 110 can be made from steel, aluminum, other metals, cardboard, wood, wax, ceramic, or other materials obvious to one skilled in the art, or combination of these materials without departing from the scope of the present invention. Furthermore, stem 110 may comprise a ribbed surface of various patterns to provide friction between the stem 110 and the cupholder to create a stopping effect.

When car seat snack tray 100 is resting inside a cupholder of a children's car seat, stem 110 typically extends up 6 inches from the base 114 to provide safe distance between the seated child and the car seat snack tray 100. The distance allows the seated child to sit comfortably while the car seat snack tray 100 is in use and to stay out of the way of any straps necessary to secure the child. However, stem 110 can be any height, shorter or longer, obvious to one skilled in the art without departing from the scope of the present invention. In an alternative embodiment, stem 110 can extend or collapse by mechanical or electrical means to adjust its height. Furthermore, base 114 may expand or shrink by mechanical or electrical means to accommodate various sizes of cupholders.

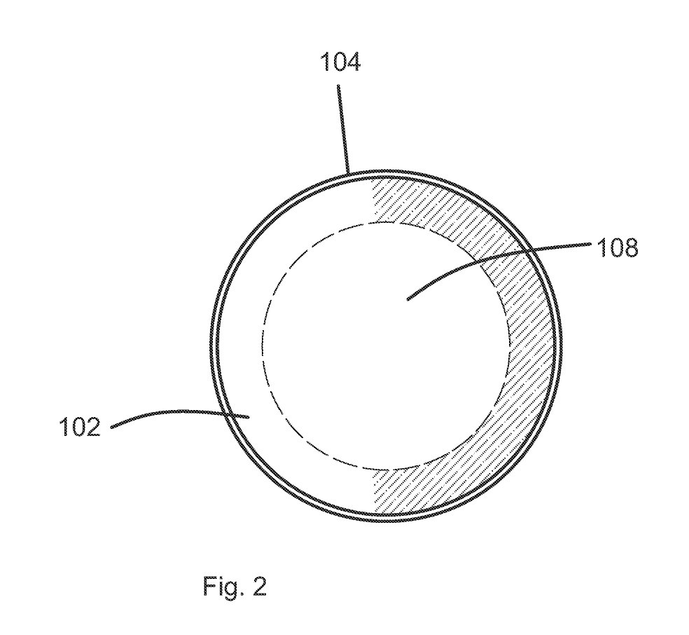

FIG. 2 illustrates a top view of the car seat snack tray 100 of the present invention. Car seat snack tray 100 is shown in FIG. 2, with bowl 102, wall 104, and bowl receptacle 108 as indicated. As shown in FIG. 2, bowl receptacle 108 is typically circular in shape, however, bowl receptacle 108 can be square, oval, rectangular, triangular, or any other shape obvious to one skilled in the art without departing from the scope of the present invention. Furthermore, bowl receptacle 108 is typically 3 inches in depth, however, bowl receptacle 108 can be any depth that can accommodate any solids and liquids accessible by children without departing from the scope of the present invention.

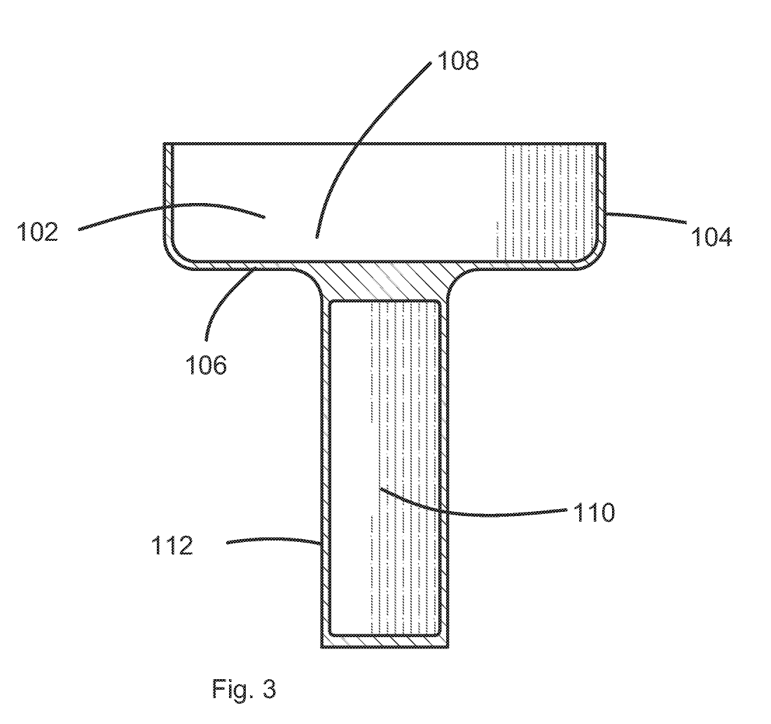

FIG. 3 illustrates a front cross-sectional view of the car seat snack tray assembly 100 of the present invention. Car seat snack tray 100 is shown in FIG. 3, with bowl 102, wall 104, bottom 106, bowl receptacle 108, stem 110, and side wall 112 as indicated. As shown in FIG. 3, stem 110 is typically integrated with the bowl 102 to form a single unit. However, it may be separately attached in other ways obvious to one skilled in the art, without departing from the scope of the present invention. Further, stem 110 is typically hollow on the inside as shown, however, stem 110 can be a solid piece of material without departing from the scope of the present invention.

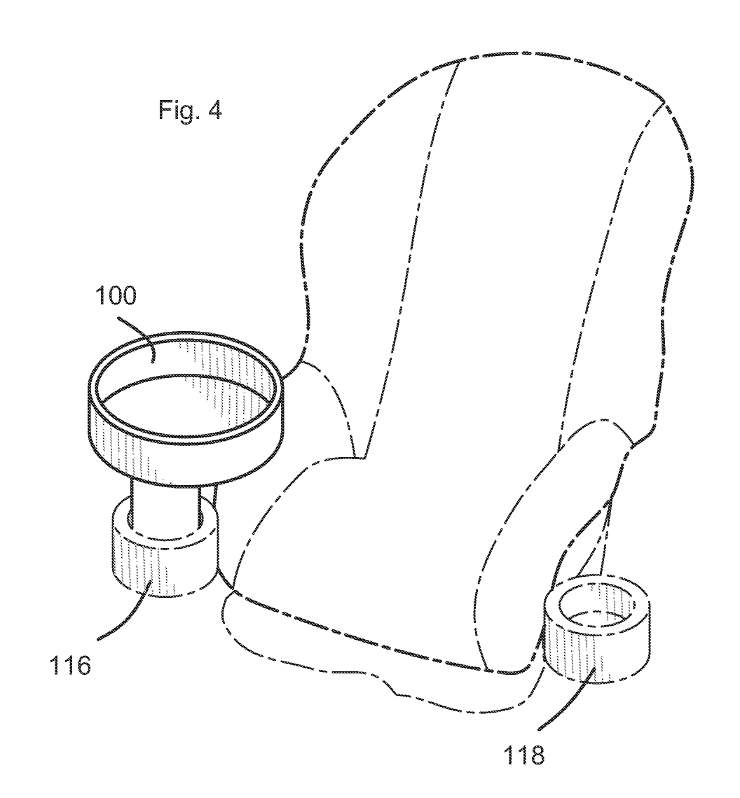

FIG. 4 illustrates a perspective view of the car seat snack tray 100 removably inserted within a cupholder 116 of a children's car seat. As shown in FIG. 4, car seat snack tray 100 can be inserted into a right arm cupholder 116 of a children's car seat. Further, car seat snack tray 100 can also be inserted into a left arm cupholder 118 of a children's car seat without departing from the scope of the present invention. Furthermore, car seat snack tray 100 may be used on any seats designed for infants and children having a built in cupholder.

What is claimed is:

1. A car seat snack tray comprising:
a bowl, having a receptacle defined by a wall and a bottom, which allows access to solids and liquids contained therein; and
a stem, attached to the bowl, having a sidewall and a base, wherein the stem slides inside a cupholder along the length of the sidewall until the base reaches the bottom surface of the cupholder.

2. The car seat snack tray of claim 1, wherein the stem is 6 inches in length.

3. The car seat snack tray of claim 2, wherein the bowl is 3 inches in depth.

4. The car seat snack tray of claim 1, wherein the bowl is oval in shape.

5. The car seat snack tray of claim 4, wherein the stem is mechanically extendable.

6. The car seat snack tray of claim 5, wherein the base is mechanically expandable.

7. The car seat snack tray of claim 6, further comprising a ribbed surface on the stem wherein the ribbed surface holds the stem in place inside a cupholder.

8. A car seat snack tray comprising:
a bowl, having a receptacle defined by a wall and a bottom, which allows access to solids and liquids contained therein; and
a stem, attached to the bowl, having a ribbed sidewall and a base, wherein the stem slides inside a cupholder along the length of the sidewall until the base reaches the bottom surface of the cupholder.

9. The car seat snack tray of claim 8, wherein the stem is mechanically extendable.

10. The car seat snack tray of claim 9, wherein the base is mechanically expandable.

11. The car seat snack tray of claim 8, wherein the stem is 6 inches in length.

12. The car seat snack tray of claim 11, wherein the bowl is 3 inches in depth.

13. The car seat snack tray of claim 10, wherein the bowl is oval in shape.

14. A car seat snack tray comprising:
a bowl, having a receptacle defined by a wall and a bottom, which allows access to solids and liquids contained therein; and
a stem, attached to the bowl, having a ribbed sidewall and a base, wherein the stem slides inside a cupholder along the length of the sidewall until the base reaches the bottom surface of the cupholder.

15. The car seat snack tray of claim 14, wherein the bowl is oval in shape.

16. The car seat snack tray of claim 15, wherein the stem is 6 inches in length.

17. The car seat snack tray of claim 16, wherein the bowl is 3 inches in depth.

18. The car seat snack tray of claim 14, wherein the stem is mechanically extendable.

19. The car seat snack tray of claim 14, wherein the base is mechanically expandable.
